(19) United States
(12) Patent Application Publication
(10) Pub. No.: US 2008/0210714 A1
(43) Pub. Date: Sep. 4, 2008

(54) BULK TEA DISPENSING SYSTEM

(75) Inventors: Umit Altun, Istanbul (TR); Emre Ergene, Istanbul (TR)

Correspondence Address: SUTHERLAND ASBILL & BRENNAN LLP, 999 PEACHTREE STREET, N.E., ATLANTA, GA, 30309, US

(73) Assignee: Atlantic Industries, Grand Cayman, KY (US)

(21) Appl. No.: 11/680,828

(22) Filed: Mar. 1, 2007

(51) Int. Cl. G01F 11/26

(52) U.S. Cl. 222/456

(57) ABSTRACT

A bulk dispenser to dispense a predetermined amount of a flowable material. The bulk dispenser may include a carton enclosed by a top assembly. An internal chimney extends into the carton and connects to the top assembly. The chimney is sized and positioned to dispense the predetermined amount of the flowable material.

### TECHNICAL FIELD

The present application relates generally to a bulk material dispensing system and more particularly relates to a bulk dispenser for tea leaves that accurately dispenses a predetermined amount of the tea leaves or other types of flowable materials.

### BACKGROUND OF THE INVENTION

Although bulk dispensing system may be well known, for example, for use with coffee beans or ground coffee, tea leaves are generally stored in conventional individual tea bags. If the tea leaves are stored in a large container, the tea leaves tend to go stale over time. As a result, single serving tea bags generally are used every time a tea beverage is requested or desired and/or multiple tea bags are used for making larger containers of tea.

There is a desire, therefore, for a bulk dispensing system for tea leaves and other types of flowable materials. Such a bulk dispenser preferably can dispense the appropriate amount of tea leaves so as to produce a given volume of brewed tea. Likewise, the bulk dispenser preferably dispenses the tea leaves while maintaining the remaining tea leaves in a fresh and substantially airtight manner. The bulk dispenser also should be easy to use and easy to refill.

### SUMMARY OF THE INVENTION

The present application thus describes a bulk dispenser to dispense a predetermined amount of a flowable material. The bulk dispenser may include a carton enclosed by a top assembly. An internal chimney extends into the carton and connects to the top assembly. The chimney is sized and positioned to dispense the predetermined amount of the flowable material.

The carton may include one or more windows positioned thereon. The top assembly may include a frame and a lid assembly. The top assembly may include a loading lid and a chimney lid. The loading lid and the chimney lid each may include one or more hinges so as to rotate about the top assembly. The chimney is connected to the chimney lid. The chimney may include a scoop within the carton. The scoop is sized and positioned to capture the predetermined amount of the flowable material. The flowable material may include tea leaves.

The present application further describes a method of dispensing a predetermined amount of a flowable material from a dispenser with an internal chimney. The method may include filling the dispenser via a loading lid, opening a chimney lid, rotating the dispenser, separating the predetermined amount of flowable material with the chimney, and dispensing the predetermined amount of flowable material from the chimney.

The method further may include returning the dispenser back to an upright position and refilling the dispenser via the loading lid. The method also may include sealing the dispenser by closing the loading lid and the chimney lid. The dispensing step may include dispensing a predetermined amount of tea leaves from the chimney.

The present application further describes a bulk dispenser to dispense a predetermined amount of tea leaves. The bulk dispenser may include a carton enclosed by a lid assembly. The lid assembly may include a loading lid and a chimney lid. An internal chimney extends into the carton and connects to the chimney lid. The chimney is sized and positioned to dispense the predetermined amount of the tea leaves.

The carton may include one or more windows positioned thereon. The lid assembly is positioned on a frame and the frame is fixedly attached to the carton. The chimney may include a scoop within the carton. The scoop is sized and positioned to capture the predetermined amount of the tea leaves. The loading lid and the chimney lid each may include one or more hinges so as to rotate about the lid assembly.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a perspective view of a bulk tea dispenser as is described herein.

FIG. 2 is an exploded view of the bulk tea dispenser of FIG. 1.

FIG. 3 is a side plan view of the bulk tea dispenser of FIG. 1.

FIG. 4 is a side plan view of the bulk tea dispenser with the dispensing door open.

FIG. 5 is a side view of the bulk tea dispenser being rotated.

FIG. 6 is a side plan view of the bulk tea dispenser dispensing an amount of tea.

FIG. 7 is a side plan view of the bulk tea dispenser dispensing an amount of tea.

FIG. 8 is a side plan view of the bulk tea dispenser being returned to its upright position.

### DETAILED DESCRIPTION

The bulk dispensers as are described herein are intended to be used with an amount of tea leaves 10. Any type and/or amount of tea leaves 10 may be used herein. The bulk dispensers described herein also can be used with other types of flowable materials, such as brewable materials like coffee beans and coffee grinds. Other type of flowable materials also may be used herein. For example, non-edible materials such as detergents and the like may be used. The scope of the invention as is claimed herein thus is not to be limited by the nature of the flowable material used therein.

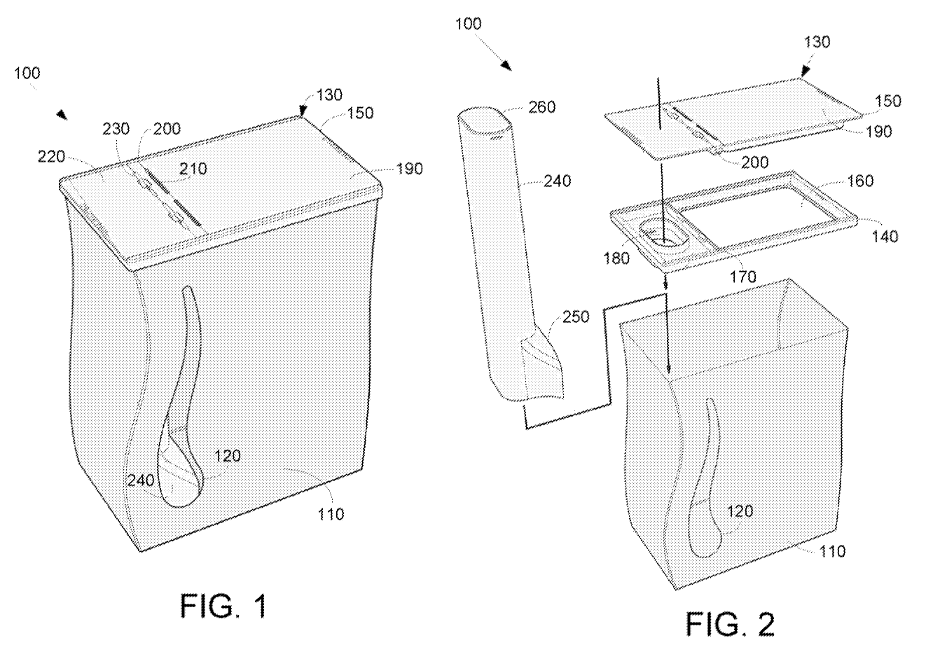

Referring now to the drawings, in which like numerals indicate like elements throughout the several views, FIGS. 1 and 2 show a bulk dispenser 100 as is described herein. As is shown, the bulk dispenser 100 includes a carton 110. The carton 110 may have any size or shape. Although the carton 110 is shown as having curves on either end, no such curves are required. In this example, the curves are somewhat tulip-shaped. The curves may have any shape. Straight sidewalls also may be used. The carton 110 may be made out of cardboard, other type of paper products, wood, plastic, metals, or any type of conventional, substantially rigid material. The carton 110 may be lined as desired.

The carton 110 may include a window 120. The window 120 allows the consumer to see the amount of tea leaves 10 present within the carton 110. Any number of windows 120 may be used on the carton 110. In this example, the window 120 has a somewhat teardrop shape. The window 120 may have any size and/or shape. The window 120 may be made out of glass, plastics, or any other type of substantially transparent material. The window 120 may be attached to the carton 110 via adhesives or other types of conventional methods.

Positioned on top of the carton 110 may be a top assembly 130. The top assembly 130 may be a two-piece element with a frame 140 connected to a lid assembly 150. The components of the top assembly 130 may be made out of plastic, metal or other types of substantially rigid materials.

The frame 140 may be sized to attach to the carton 110. The frame 140 includes a loading aperture 160 on one end thereof so as to load the tea leaves 10 therein as will be described in more detail below. The loading aperture 160 is relatively wide so as to provide easy loading. Any size and shape may be used herein. Adjacent to the loading aperture 160 may be a connector flange 170. The lid assembly 150 may be seated on the connector flange 170 also as is described in more detail below. Other types of connection means may be used herein. Adjacent to the connector flange 170 may be a chimney aperture 180. The chimney aperture 180 may be used for dispensing the tea leaves 10 as is described in more detail below. Any size or shape may be used.

The lid assembly 150 includes a loading lid 190. The loading lid 190 is sized to enclose the loading aperture 160. The loading lid 190 may have a clasp or other type of locking mechanism so as to maintain the loading lid 190 in a sealed position with respect to the loading aperture 160. The lid assembly 150 further may include a connection bar 200. The connection bar 200 may cooperate with the connector flange 170 so as to maintain the lid assembly 150 in place with respect to the frame 140. The loading lid 190 may be attached to the connection bar 200 by a pair of loading lid hinges 210. Other types of connection means may be used herein. Attached on the other side of the connector bar 200 may be a chimney lid 220. The chimney lid 220 may be sized to enclose the chimney aperture 180. The chimney lid 190 may have a clasp or other type of locking mechanism so as to maintain the chimney lid 220 in a sealed position with respect to the chimney aperture 180. The chimney lid 220 may be attached to the connection bar 200 via a pair of chimney lid hinges 230. Other types of conventional connection or rotation devices may be used herein.

Positioned within the carton 110 and attached to the top assembly 130 may be a chimney 240. The chimney 240 may have a wide mouth scoop 250 positioned within the carton 110 and a top opening 260 connected to the chimney aperture 180 of the lid assembly 150. The scoop 250 may be sized and/or positioned such that a predetermined amount of tea leaves 10 falls into the scoop 250 when the bulk dispenser 100 is rotated. The chimney 240 may be made out of plastic, metals, or other types of conventional materials. The chimney 240 may be fixably attached to the chimney aperture 180.

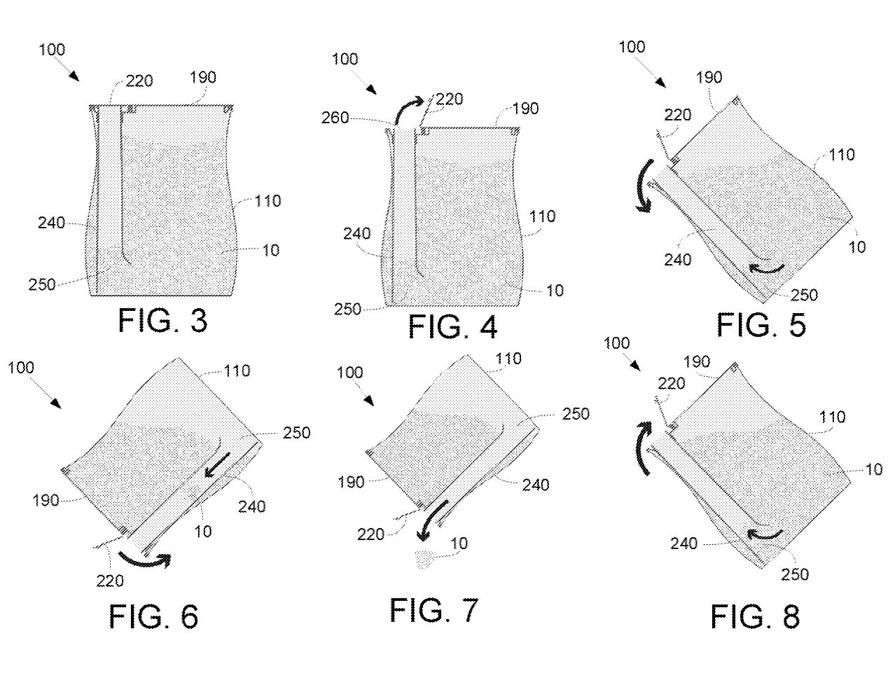

FIGS. 3-8 show use of the bulk dispenser 100. As is shown, an amount of tea leaves 10 or other types of flowable material is positioned within the carton 110 via the loading lid 190 and the loading aperture 160. The loading lid 190 is then closed and secured. A predetermined amount of tea leaves 10 settles around the scoop 250 of the chimney 240.

As is shown in FIG. 4, the chimney lid 220 is opened and the bulk dispenser 100 begins to rotate as is shown in FIG. 5. As is shown in FIG. 6, once the bulk dispenser 100 is rotated to a certain degree, the tea leaves 10 within the carton 110 fall under forced gravity towards the loading lid 190. The scoop 250 of the chimney 240 also captures or separates a predetermined amount of the tea leaves 10 into the chimney 240 where the tea leaves 10 head towards the top opening 260 of the chimney 240. As is shown in FIG. 7, that predetermined amount of tea leaves 10 is then dispensed through the chimney aperture 190. In this example, the chimney 250 is sized and spaced so as to dispense the ideal amount of tea leaves 10 to prepare two (2) glasses of tea.

As is shown in FIG. 8, when the bulk dispenser 100 is returned to its upright position, the tea leaves 10 again fall towards the bottom of the carton 110 under the force of gravity and another predetermined amount of tea leaves 10 settles about the scoop 250 of the chimney 240. The bulk dispenser 100 can be turned as many times as desired for the intended number of glasses. The process is then repeated until the carton 110, as viewed via the window 120, is almost empty of the tea leaves 10. The loading lid 190 then may be opened and the carton 110 may be filled again with tea leaves 10 or other materials. The bulk dispenser 100 may be refilled any number of times.

It should be apparent that the foregoing relates only to the preferred embodiments of the present application and that numerous changes and modifications mat be made herein by one of ordinary skill in the art without departing from the general spirit and scope of the invention as defined by the following claims and equivalents thereof.

We claim:

1. A bulk dispenser to dispense a predetermined amount of a flowable material, comprising:
a carton;
the carton enclosed by a top assembly; and
an internal chimney extending into the carton and connected to the top assembly;
the chimney being sized and positioned to dispense the predetermined amount of the flowable material.

2. The bulk dispenser of claim 1, wherein the carton comprises one or more windows positioned thereon.

3. The bulk dispenser of claim 1, wherein the top assembly comprises a frame and a lid assembly.

4. The bulk dispenser of claim 1, wherein the top assembly comprises a loading lid and a chimney lid.

5. The bulk dispenser of claim 4, wherein the loading lid and the chimney lid each comprise one or more hinges so as to rotate about the top assembly.

6. The bulk dispenser of claim 4, wherein the chimney is connected to the chimney lid.

7. The bulk dispenser of claim 1, wherein the chimney comprises a scoop within the carton.

8. The bulk dispenser of claim 7, wherein the scoop is sized and positioned to capture the predetermined amount of the flowable material.

9. The bulk dispenser of claim 1, wherein the flowable material comprises tea leaves.

10. A method of dispensing a predetermined amount of a flowable material from a dispenser with an internal chimney, comprising:
filling the dispenser via a loading lid;
opening a chimney lid;
rotating the dispenser;
separating the predetermined amount of flowable material with the chimney; and
dispensing the predetermined amount of flowable material from the chimney.

11. The method of claim 10, further comprising returning the dispenser back to an upright position.

12. The method of claim 10, further comprising refilling the dispenser via the loading lid.

13. The method of claim 10, further comprising sealing the dispenser by closing the loading lid and the chimney lid.

14. The method of claim 10, wherein the dispensing step comprises dispensing a predetermined amount of tea leaves from the chimney.

15. A bulk dispenser to dispense a predetermined amount of tea leaves, comprising:
a carton;
the carton enclosed by a lid assembly;
the lid assembly comprising a loading lid and a chimney lid; and
an internal chimney extending into the carton and connected to the chimney lid;
the chimney being sized and positioned to dispense the predetermined amount of the tea leaves.

16. The bulk dispenser of claim 15, wherein the carton comprises one or more windows positioned thereon.

17. The bulk dispenser of claim 15, wherein the lid assembly is positioned on a frame and wherein the frame is fixedly attached to the carton.

18. The bulk dispenser of claim 15, wherein the chimney comprises a scoop within the carton.

19. The bulk dispenser of claim 18, wherein the scoop is sized and positioned to capture the predetermined amount of the tea leaves.

20. The bulk dispenser of claim 15, wherein the loading lid and the chimney lid each comprise one or more hinges so as to rotate about the lid assembly.
